(19) United States
(12) Patent Application Publication
(10) Pub. No.: US 2022/0113659 A1
(43) Pub. Date: Apr. 14, 2022

(54) IMAGE FORMING APPARATUS

(71) Applicant: FUJIFILM Business Innovation Corp., Tokyo (JP)

(72) Inventors: Shohei MIYAGAWA, Yokohama-shi (JP); Mitsuaki KURODA, Yokohama-shi (JP); Naoya KAMIGAITO, Yokohama-shi (JP); Atsuna SAIKI, Ebina-shi (JP)

(73) Assignee: FUJIFILM Business Innovation Corp., Tokyo (JP)

(21) Appl. No.: 17/559,402

(22) Filed: Dec. 22, 2021

Related U.S. Application Data
(63) Continuation of application No. PCT/JP2020/034778, filed on Sep. 14, 2020.

(30) Foreign Application Priority Data
Sep. 20, 2019 (JP) 2019-171943
Jun. 4, 2020 (JP) PCT/JP2020/022190
Aug. 12, 2020 (JP) 2020-136294

(51) Int. Cl. G03G 15/20

(52) U.S. Cl. CPC G03G 15/2028

(57) ABSTRACT

An image forming apparatus includes: an image forming unit that includes a first drum supporting a recording medium and a first rotating body disposed at an axial end of the first drum, and that is configured to form an image on the recording medium; a fixing unit that includes a second drum supporting the recording medium and a second rotating body disposed at an axial end of the second drum, and that is configured to fix the image to the recording medium by heating or drying the recording medium; and a transport unit that includes a rotating member stretched between the first rotating body and the second rotating body and rotating with rotation of the first rotating body and the second rotating body and a holding unit attached to the rotating member and holding the recording medium, and that is configured to transport the recording medium from the image forming unit to the fixing unit by the rotation of the rotating member.

### CROSS-REFERENCE TO RELATED APPLICATIONS

This is a continuation of International Application No. PCT/JP2020/034778 filed on Sep. 14, 2020, and claims priorities under 35 USC 119 from Japanese Patent Application No. 2019-171943 filed on Sep. 20, 2019, International Application No. PCT/JP2020/022190 filed on Jun. 4, 2020, and Japanese Patent Application No. 2020-136294 filed on Aug. 12, 2020.

### BACKGROUND

### Technical Field

The present invention relates to an image forming apparatus.

### Related Art

JP-A-2012-96863 discloses a configuration in which a gripper provided on a circumferential surface of a transport drum grips a tip end portion of a paper to transport the paper.

### SUMMARY

In a configuration in which a recording medium is transported by rotating a rotating member to which a holding unit holding a recording medium is attached, when the rotating member is disposed in each of an image forming unit that forms an image on the recording medium and a fixing unit that fixes the image to the recording medium, and the recording medium is delivered between holding units of the respective rotating members, a large space is required.

Aspects of non-limiting embodiments of the present disclosure relate to saving space in an image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including:

an image forming unit that includes a first drum supporting a recording medium and a first rotating body disposed at an axial end of the first drum, and that is configured to form an image on the recording medium;

a fixing unit that includes a second drum supporting the recording medium and a second rotating body disposed at an axial end of the second drum, and that is configured to fix the image to the recording medium by heating or drying the recording medium; and

a transport unit that includes a rotating member stretched between the first rotating body and the second rotating body and rotating with rotation of the first rotating body and the second rotating body and a holding unit attached to the rotating member and holding the recording medium, and that is configured to transport the recording medium from the image forming unit to the fixing unit by the rotation of the rotating member.

### BRIEF DESCRIPTION OF DRAWINGS

Exemplary embodiment(s) of the present invention will be described in detail based on the following figures, wherein:

FIG. 1 is a schematic diagram illustrating an image forming apparatus according to the present exemplary embodiment;

FIG. 2 is an enlarged perspective view illustrating a secondary transfer portion of the image forming apparatus according to the present exemplary embodiment;

FIG. 3 is an enlarged side view illustrating the secondary transfer portion of the image forming apparatus according to the present exemplary embodiment;

FIG. 4 is a side view illustrating a sprocket provided in a transfer drum according to the present exemplary embodiment;

FIG. 5 is a perspective view illustrating a gripper according to the present exemplary embodiment;

FIG. 6 is a side view illustrating a sprocket provided in a pressure roller according to the present exemplary embodiment;

FIG. 7 is a side view illustrating the pressure roller according to the present exemplary embodiment;

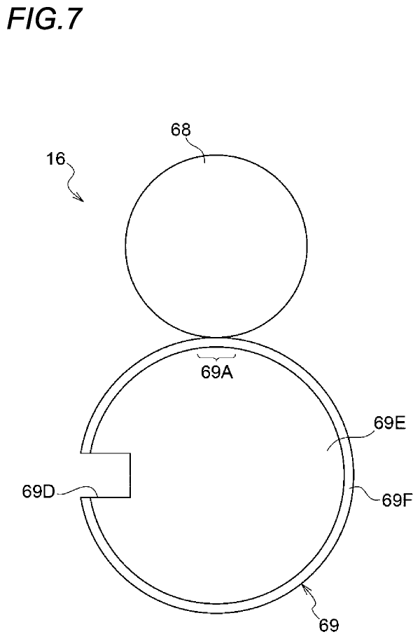

FIG. 8 is a perspective view illustrating a gripper according to a modification; and

FIG. 9 is an enlarged side view illustrating a secondary transfer portion according to the modification.

### DETAILED DESCRIPTION

Hereinafter, an example of an exemplary embodiment according to the present invention will be described with reference to the drawings.

(Image Forming Apparatus 10)

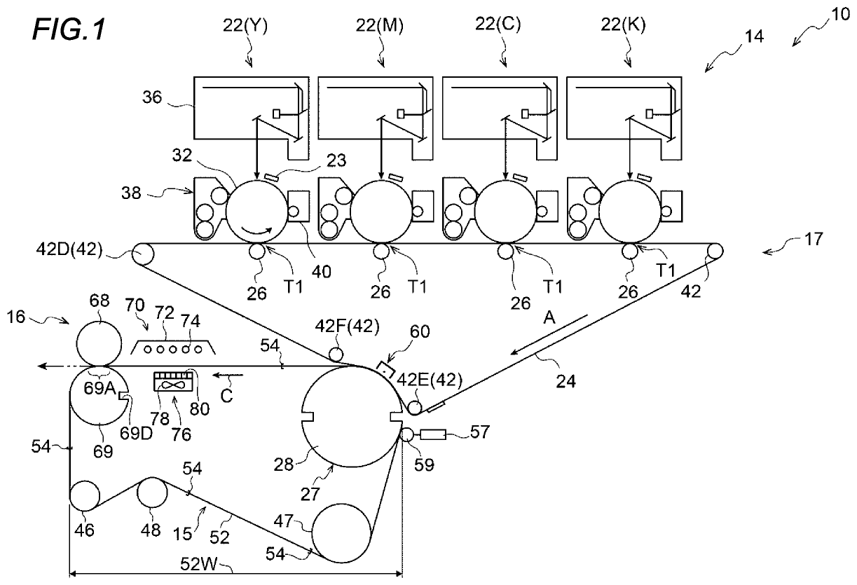

A configuration of an image forming apparatus 10 according to the present exemplary embodiment will be described. FIG. 1 is a schematic diagram illustrating a configuration of the image forming apparatus 10 according to the present exemplary embodiment.

The image forming apparatus 10 illustrated in FIG. 1 is an example of an image forming apparatus that forms an image on a recording medium. Specifically, the image forming apparatus 10 is an electrophotographic image forming apparatus that forms a toner image (an example of an image) on a recording medium P. More specifically, the image forming apparatus 10 includes an image forming unit 14, a transport unit 15, and a fixing device 16. Hereinafter, each unit of the image forming apparatus 10 (that is, the image forming unit 14, the transport unit 15, and the fixing device 16) will be described.

(Image Forming Unit 14)

The image forming unit 14 has a function of forming a toner image (an example of an image) on the recording medium P. Specifically, the image forming unit 14 includes a toner image forming unit 22 and a transfer device 17.

(Toner Image Forming Unit 22)

Plural toner image forming units 22 illustrated in FIG. 1 are provided so as to form a toner image for each color. In the present exemplary embodiment, the toner image forming units 22 of a total of four colors of yellow (Y), magenta (M), cyan (C), and black (K) are provided. The (Y), (M), (C), and (K) illustrated in FIG. 1 indicate constituent portions corresponding to the respective colors.

In the image forming apparatus 10, when it is necessary to distinguish yellow (Y), magenta (M), cyan (C), and black (K), the (Y), (M), (C), and (K) are attached after reference numerals of respective members, and when it is not necessary to distinguish the respective colors, the (Y), (M), (C), and (K) may be omitted. Since the toner image forming unit 22 of each color has the same configuration except for the toner to be used, on behalf of the toner image forming unit 22 of each color, each part of the toner image forming unit 22(Y) is denoted by a reference numeral in FIG. 1.

Specifically, the toner image forming unit 22 of each color includes a photoconductor drum 32 that is a photoconductor that rotates in one direction (for example, in a counterclockwise direction in FIG. 1). Further, the toner image forming unit 22 of each color includes a charger 23, an exposure device 36, a developing device 38, and a removing device 40.

In the toner image forming unit 22 of each color, the charger 23 charges the photoconductor drum 32. Further, the exposure device 36 exposes the photoconductor drum 32 charged by the charger 23 to form an electrostatic latent image on the photoconductor drum 32. The developing device 38 develops the electrostatic latent image, which is formed on the photoconductor drum 32 by the exposure device 36, to form a toner image. The removing device 40 removes toner remaining on the photoconductor drum 32 after the toner image is transferred to a transfer belt 24 to be described later.

(Transfer Device 17)

As illustrated in FIG. 1, the transfer device 17 includes the transfer belt 24, a primary transfer roller 26, a secondary transfer body 27, and a charger 60. The transfer device 17 illustrated in FIG. 1 is a device that transfers the toner image formed by the toner image forming unit 22 onto the recording medium P. Specifically, the transfer device 17 primarily transfers the toner image of the photoconductor drum 32 of each color onto the transfer belt 24 as an intermediate transfer body in a superimposed manner, and secondarily transfers the superimposed toner images onto the recording medium P at a secondary transfer position T2 (that is, a nip region 28A to be described later).

(Primary Transfer Roller 26)

The primary transfer roller 26 illustrated in FIG. 1 is a roller that transfers the toner image of the photoconductor drum 32 of each color to the transfer belt 24 at a primary transfer position T1 between the photoconductor drum 32 and the primary transfer roller 26. In the present exemplary embodiment, the toner image formed on the photoconductor drum 32 is transferred to the transfer belt 24 at the primary transfer position T1 by applying a primary transfer electric field between the primary transfer roller 26 and the photoconductor drum 32.

(Transfer Belt 24)

The transfer belt 24 illustrated in FIG. 1 is an example of an annular transfer belt on which an image is transferred to an outer surface. Specifically, the toner image is transferred from the photoconductor drum 32 of each color to an outer circumferential surface (an example of the outer surface) of the transfer belt 24. More specifically, the transfer belt 24 is configured as follows. As illustrated in FIG. 1, the transfer belt 24 is annular. Further, the transfer belt 24 is wound around plural rollers 42 including a driving roller 42D and winding rollers 42E and 42F, and a posture of the transfer belt 24 is determined. For example, the driving roller 42D among the plural rollers 42 is rotationally driven by a driving unit (not shown), and thus the transfer belt 24 rotates in a predetermined arrow A direction (hereinafter, referred to as a belt rotation direction A). Specific configurations of the winding rollers 42E and 42F will be described later.

(Secondary Transfer Body 27)

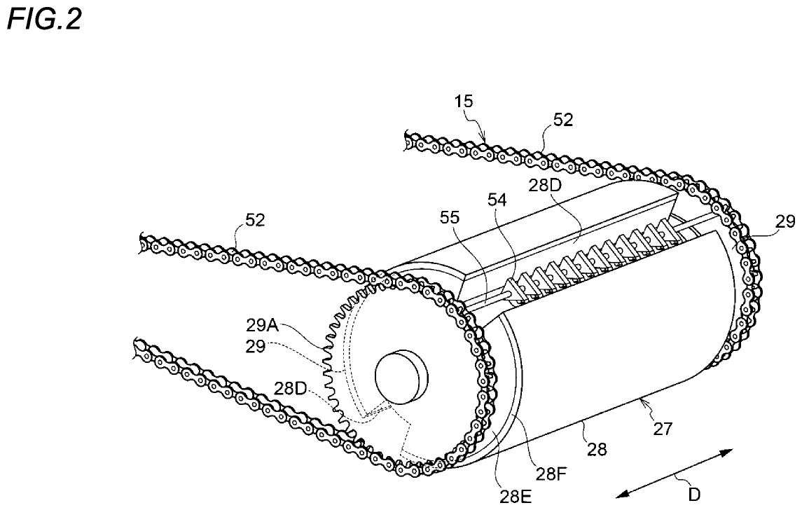

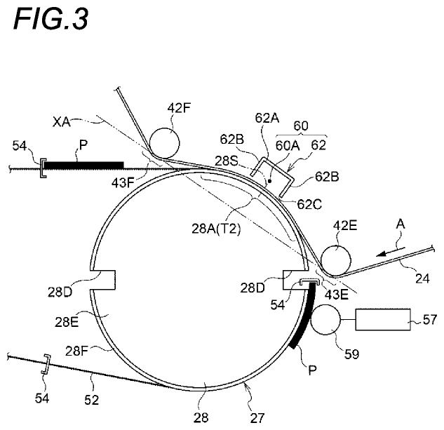

The secondary transfer body 27 is an example of a transfer unit. Specifically, as illustrated in FIG. 2, the secondary transfer body 27 includes a transfer drum 28 as an example of a first drum and a pair of sprockets 29. The transfer drum 28 is an example of a transfer drum having a transfer region where an image is transferred from the transfer belt to the recording medium by sandwiching the recording medium with the outer surface of the transfer belt. Specifically, as illustrated in FIG. 3, the transfer drum 28 includes the nip region 28A (an example of the transfer region) that sandwiches the recording medium P with the outer circumferential surface of the transfer belt 24. Since the nip region 28A is a region where the recording medium P is sandwiched, the nip region 28A is also referred to as a sandwiched region. Since the transfer drum 28 sandwiches the recording medium P with the transfer belt 24, the transfer drum 28 is also referred to as a sandwiching portion. In FIG. 3, the recording medium P is simplified and a part thereof is shown.

The nip region 28A is formed by winding the transfer belt 24 around the transfer drum 28 and covering (lapping) a part of the transfer drum with the transfer belt 24. In other words, the nip region 28A is also referred to as a contact region in which the transfer belt 24 and the transfer drum 28 are in contact with each other. The nip region 28A is the secondary transfer position T2 at which the toner image is transferred from the transfer belt 24 to the recording medium P. The transfer drum 28 transports the recording medium P while sandwiching the recording medium P between the transfer drum 28 and the transfer belt 24 in the nip region 28A. Further, for example, in a case where transfer is performed on a wide paper (a wide recording medium) such as a B2 size, in the transfer region, the recording medium P may be violent or the recording medium P may flutter, resulting in displacement or disturbance of a transferred image. However, in the case of the present exemplary embodiment, the nip region 28A in which the transfer belt 24 covers and contacts the transfer drum 28 prevents the fluttering of the recording medium P and prevents the displacement and disturbance of the transferred image. In particular, in a case where a facing member of the transfer drum 28 is a rotating body, when a radius of the transfer drum 28 is larger than a radius of the rotating body, the transfer belt 24 is more likely to cover the transfer drum 28, and a curvature of a covered region is small.

The pair of sprockets 29 is an example of a first rotating body. As illustrated in FIG. 2, the pair of sprockets 29 is disposed at an axial end of the transfer drum 28. Specifically, the pair of sprockets 29 are disposed on both axial end sides of the transfer drum 28. In other words, the transfer drum 28 is provided between the pair of sprockets 29. The pair of sprockets 29 are disposed coaxially with the transfer drum 28 and rotate integrally with the transfer drum 28. The secondary transfer body 27 is rotationally driven by the driving unit (not shown). In the present exemplary embodiment, an axial direction of the transfer drum 28 is a direction the same as an apparatus front-rear direction (a direction D in FIG. 2).

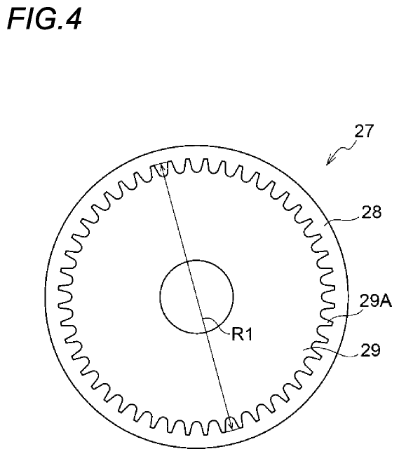

As illustrated in FIG. 4, an outer diameter R1 of the pair of sprockets 29 is smaller than an outer diameter of the transfer drum 28. Here, the outer diameter R1 of the sprocket 29 is an outer diameter including a tooth 29A (that is, a diameter of a tooth tip). The outer diameter R1 of the sprocket 29 is preferably in a range of 50% to 95%, and more preferably in a range of 70% to 90% with respect to the outer diameter of the transfer drum 28. In other words, the outer diameter R1 of the sprocket 29 may be set such that a chain 52 does not protrude from an outer circumference of the transfer drum 28 in a portion wound around the sprocket 29 of the chain 52.

The transfer drum 28 includes a base material 28E and a surface layer 28F that is wound around an outer circumference of the base material 28E and that is replaceable with respect to the base material 28E. As the base material 28E, a metal material such as stainless steel is used. As the surface layer 28F, a resin material having elasticity such as urethane rubber, ethylene propylene rubber (EPM), silicone rubber, fluorine rubber (FKM), epichlorohydrin/butadiene rubber, or the like is used. The surface layer 28F is detachably fixed to the base material 28E. Therefore, it may be possible to remove the surface layer 28F with respect to the base material 28E and attach an unused surface layer 28F. When the toner image is transferred from the transfer belt 24 to the recording medium P, the transfer drum 28 sandwiches the recording medium P at a predetermined pressure between the surface layer 28F and the outer circumferential surface of the transfer belt 24, and causes the recording medium P to pass through the nip region 28A.

Further, on the outer circumference of the transfer drum 28, two recesses 28D are formed in which a gripper 54 and an attachment member 55 of the transport unit 15 to be described later are accommodated. The number of the recesses 28D may be one, or may be three or more.

(Charger 60)

The charger 60 is an example of a facing portion that faces the sandwiched portion inside the transfer belt. As illustrated in FIG. 3, the charger 60 is disposed inside the transfer belt 24 so as to face the transfer drum 28. Specifically, the charger 60 faces the transfer drum 28 in a region including a center 28S of the nip region 28A in a transport direction of the transport unit 15.

The charger 60 is a charger (so-called corotron charger) that transfers a toner image on the transfer belt 24 by corona discharge. Specifically, the charger 60 includes a discharge wire 60A and a case 62 that is a housing. The discharge wire 60A has a linear shape having a length extending along the axial direction of the transfer drum 28. The discharge wire 60A is not in contact with an inner surface of the transfer belt 24. That is, there is a gap between the discharge wire 60A and the inner surface of the transfer belt 24.

The case 62 is an example of a surrounding portion that surrounds the discharge wire. The case 62 is formed in a box shape, and includes an opening portion 62C on a transfer drum 28 side (that is, a lower side).

Specifically, the case 62 includes a first wall 62A disposed on a side opposite to the transfer drum 28 with respect to the discharge wire 60A, and a pair of second walls 62B disposed on an upstream side and a downstream side in the belt rotation direction A with respect to the discharge wire 60A. Further, the case 62 has third walls (not shown) disposed on both end sides in a length direction of the discharge wire 60A.

The case 62 is not in contact with the inner surface of the transfer belt 24. That is, there is a gap between the case 62 and the inner surface of the transfer belt 24.

The case 62 may include an opening portion in the third walls (not shown) or the like disposed on the both end sides in the length direction of the discharge wire 60A, and may include an opening portion 62C at least on the transfer drum 28 side (that is, the lower side).

In the charger 60, a voltage is applied to the discharge wire 60A and the discharge wire 60A discharges, so that the recording medium P is electrostatically adsorbed to the transfer belt 24 and the transfer drum 28. In the charger 60, the transfer belt 24 is charged due to the discharge of the discharge wire 60A, and the toner images superimposed on the transfer belt 24 are transferred from the transfer belt 24 to the recording medium P in the nip region 28A, which is the secondary transfer position T2.

(Winding Rollers 42E and 42F)

The winding rollers 42E and 42F illustrated in FIGS. 1 and 3 are examples of a pair of winding rollers on which the transfer belt is wound inside the transfer belt. The number of the winding rollers is not necessarily a pair, and may be only one. In the present exemplary embodiment, the winding rollers 42E and 42F are constituted by a rotating body, but the winding roller may be constituted by a sliding member in which a nonwoven fabric or the like is bonded to a front surface of a metal body that is not rotated. The winding rollers 42E and 42F are disposed on the upstream side and the downstream side in the belt rotation direction A with respect to the charger 60.

As illustrated in FIG. 3, the winding rollers 42E and 42F are disposed such that a common external tangent XA of the winding rollers 42E and 42F passes over the transfer drum 28 when viewed in the axial direction of the winding rollers 42E and 42F.

Here, the common external tangent XA is a tangent line in which the winding rollers 42E and 42F are disposed on the same side of the tangent line among tangent lines (that is, common tangent lines) tangent to both the winding rollers 42E and 42F. More specifically, the common external tangent XA according to the present exemplary embodiment is a tangent line tangent to the portions of the winding rollers 42E and 42F around which transfer belt 24 is wound. In other words, the common external tangent XA according to the present exemplary embodiment is a tangent line that is in contact with the winding rollers 42E and 42F on the transfer drum 28 side with respect to the charger 60.

In the present exemplary embodiment, both of winding portions 43E and 43F wound around the winding rollers 42E and 42F of the transfer belt 24 are separated from the transfer drum 28, but one or both of the winding portions 43E and 43F may be in contact with the transfer drum 28. The winding portion 43E is a winding portion on an upstream side in the transport direction of the recording medium P with respect to the winding portion 43F.

(Fixing Device 16)

The fixing device 16 illustrated in FIG. 1 is a device that fixes the toner image transferred to the recording medium P by the transfer drum 28 to the recording medium P. Specifically, as illustrated in FIG. 1, the fixing device 16 includes a heating roller 68 as a heating member, a pressure roller 69 as a pressure member, and a pair of sprockets 19. In FIG. 1, the sprocket 19 is omitted. In the fixing device 16, by heating and pressurizing the recording medium P by the heating roller 68 and the pressure roller 69, the toner image formed on the recording medium P is fixed to the recording medium P. The fixing device 16 is an example of a fixing unit. The pressure roller 69 is an example of a second drum.

The pair of sprockets 19 is an example of a second rotating body. The pair of sprockets 19 is disposed at an axial end of the pressure roller 69. Specifically, the pair of sprockets 19 are disposed on both axial end sides of the pressure roller 69. In other words, the pressure roller 69 is provided between the pair of sprockets 19. Further, the pair of sprockets 19 are disposed coaxially with the pressure roller 69, and rotate integrally with the pressure roller 69.

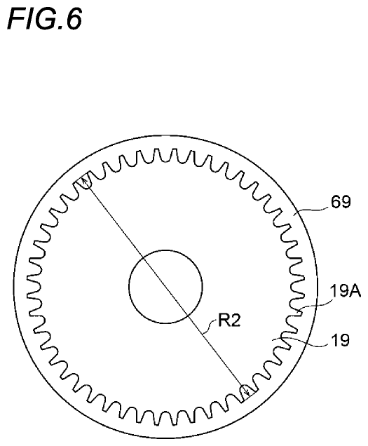

As illustrated in FIG. 6, an outer diameter R2 of the pair of sprockets 19 is smaller than an outer diameter of the pressure roller 69. Here, the outer diameter R2 of the sprocket 19 is an outer diameter including a tooth 19A (that is, the diameter of the tooth tip). The outer diameter R2 of the sprocket 19 is preferably in a range of 50% to 95%, and more preferably in a range of 70% to 90% with respect to the outer diameter of the pressure roller 69. In other words, the outer diameter R2 of the sprocket 19 may be set such that the chain 52 does not protrude from an outer circumference of the pressure roller 69 in a portion wound around the sprocket 19 of the chain 52.

On the outer circumference of the pressure roller 69, one recess 69D is formed in which the gripper 54 and the attachment member 55 of the transport unit 15 to be described later are accommodated. Plural recesses 69D may be formed according to an arrangement interval of the grippers 54 along a rotation direction C of the chain 52.

The pressure roller 69 includes a base material 69E and a surface layer 69F that is wound around an outer circumference of the base material 69E and that is replaceable with respect to the base material 69E. As the base material 69E, a metal material such as stainless steel is used. As the surface layer 69F, an elastic material such as silicone rubber or a material obtained by sequentially stacking a release layer made of PFA or the like on the elastic material such as silicone rubber is used. The surface layer 69F is detachably fixed to the base material 69E. Therefore, it may be possible to remove the surface layer 69F with respect to the base material 69E and attach an unused surface layer 69F.

(Transport Unit 15)

The transport unit 15 illustrated in FIGS. 1 to 3 and the like has a function of transporting the recording medium P from the image forming unit 14 to the fixing device 16. Specifically, the transport unit 15 has a function of transporting the recording medium P and causing the recording medium P to pass through the nip region 28A of the image forming unit 14 and a nip region 69A of the fixing device 16 illustrated in FIG. 3. More specifically, as illustrated in FIGS. 1 and 2, the transport unit 15 includes the pair of sprockets 19, the pair of sprockets 29, a pair of sprockets 46, a pair of sprockets 47, a pair of sprockets 48, a pair of chains 52, the gripper 54, and an adsorption roller 59. The pair of chains 52 is an example of a rotating member. The gripper 54 is an example of a holding unit that holds the recording medium. In FIG. 1, the sprocket 46, the sprocket 47, the sprocket 48, the chain 52, and the gripper 54 are simplified, and the sprocket 19 and the sprocket 29 are omitted. In FIG. 3, the chain 52 and the gripper 54 are simplified.

As illustrated in FIG. 1, the pair of sprockets 46 are disposed at a lower side of the pair of sprockets 19 at intervals in the apparatus front-rear direction. The pair of sprockets 46 are coaxially and integrally rotatable and supported by an apparatus body (not shown) of the image forming apparatus 10.

As illustrated in FIG. 1, the pair of sprockets 47 are disposed at a lower side of the pair of sprockets 29 at intervals in the apparatus front-rear direction. The pair of sprockets 47 are coaxially and integrally rotatable and supported by the apparatus body (not shown) of the image forming apparatus 10.

As illustrated in FIG. 1, the pair of sprockets 48 are disposed between the pair of sprockets 46 and the pair of sprockets 47 in an apparatus width direction (a left-right direction in FIG. 1) at intervals in the apparatus front-rear direction. The pair of sprockets 48 are coaxially and integrally rotatable and supported by the apparatus body (not shown) of the image forming apparatus 10.

The sprockets 46, 47, and 48 have a function of appropriately maintaining a tension of the chain 52.

As illustrated in FIG. 1, the pair of chains 52 are formed in an annular shape. As illustrated in FIG. 2, the pair of chains 52 are disposed at intervals in the apparatus front-rear direction (direction D in FIG. 2). Each of the pair of chains 52 is stretched around the pair of sprockets 19 provided in the pressure roller 69 and the pair of sprockets 29 provided in the transfer drum 28. Specifically, each of the pair of chains 52 is wound around the pair of sprockets 19, 29, 46, 47, and 48. When the transfer drum 28 having the pair of sprockets 29 rotates, the chain 52 rotates in the rotation direction C (an arrow C direction in FIG. 1). Here, the chain 52 is wound so as to straddle at least a region of the nip region 28A facing the charger 60 in the rotation direction C. As a result, since the recording medium P is transported by the chain 52 during secondary transfer, a speed fluctuation of the recording medium P is prevented at the secondary transfer position T2. Further, the chain 52 is wound so as to straddle the entire nip region 28A. As a result, the speed fluctuation of the recording medium P is more reliably prevented at the secondary transfer position T2. In the present exemplary embodiment, a winding angle at which the chain 52 is wound around the sprocket 29 is 90 degrees or more. Therefore, the recording medium P is likely to be transported along a front surface of the transfer drum 28.

In the present exemplary embodiment, the pair of sprockets 19, 46, 47, and 48 are driven to rotate with respect to the rotation of the chain 52.

As illustrated in FIG. 1, a width from a portion where the chain 52 is wound around the sprocket 29 to a portion where the chain 52 is wound around the sprocket 19 is a maximum width portion 52W which is a maximum width of the transport unit 15 in the apparatus width direction when viewed from the apparatus front-rear direction. In other words, the sprockets 46, 47, and 48 of the transport unit 15 are disposed in a region along the apparatus width direction from the sprocket 19 to the sprocket 29.

As illustrated in FIG. 2, the attachment member 55 to which the gripper 54 is attached is stretched along the apparatus front-rear direction in the pair of chains 52. Plural attachment members 55 are fixed to the pair of chains 52 at predetermined intervals along a circumferential direction (rotation direction C) of the chain 52.

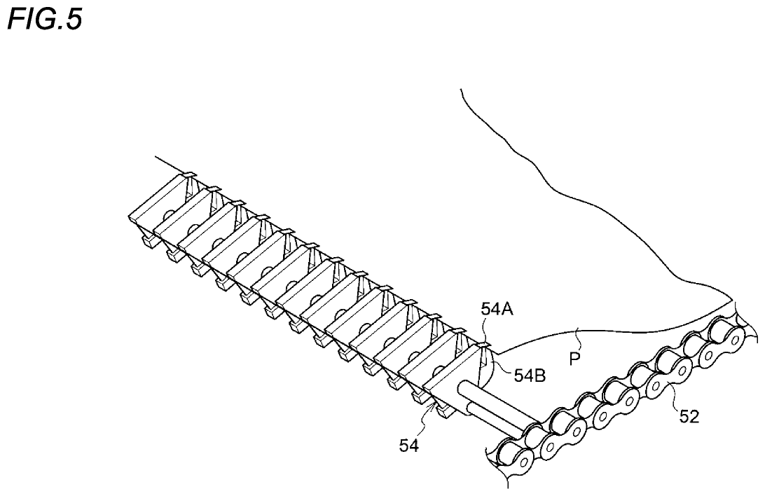

As illustrated in FIG. 2, plural grippers 54 are attached to the attachment member 55 at predetermined intervals along the apparatus front-rear direction. In other words, the grippers 54 are attached to the chains 52 via the attachment member 55. The gripper 54 has a function of holding a front end portion of the recording medium P. Specifically, as illustrated in FIG. 5, the gripper 54 includes a claw 54A and a claw base 54B. The gripper 54 holds the recording medium P by sandwiching the front end portion of the recording medium P between the claw 54A and the claw base 54B. In other words, the gripper 54 is an example of a gripping portion that sandwiches the recording medium P in a thickness direction.

More specifically, the gripper 54 holds the front end portion of the recording medium P outside an image region of the recording medium P. The image region of the recording medium P is an area onto which a toner image is transferred in the recording medium P. In the gripper 54, for example, the claw 54A is pressed against the claw base 54B by a spring or the like, and the claw 54A is opened and closed with respect to the claw base 54B by action of a cam or the like.

As illustrated in FIG. 5, the transport unit 15 holds, by the grippers 54, the front end portion of the recording medium P transmitted from an accommodating portion (not shown) in which the recording medium P is accommodated. Further, in the transport unit 15, the chains 52 rotate in the rotation direction C in a state in which the grippers 54 hold the front end portion of the recording medium P, thus the grippers 54 are moved to transport the recording medium P, and the recording medium P passes through the nip region 28A together with the grippers 54 while the recording medium P is held by the grippers 54. Further, in the transport unit 15, after passing the recording medium P through the nip region 28A, the recording medium P is transported to the fixing device 16 while the recording medium P is held by the grippers 54, and the recording medium P passes through the nip region 69A together with the grippers 54. Here, the nip region 69A is an example of a fixing region and a heating region in the present invention. In the fixing region of the present invention, in addition to the nip region 69A, at least one of a region on an upstream side in the transport direction and a region on a downstream side in the transport direction of the nip region 69A may be included. The fixing region is not limited to the nip region 69A, and may be a heating region facing a non-contact heating unit 70 to be described later. As described above, since the recording medium P is transported without being delivered from the transfer region to the fixing region, it may be possible to prevent an unfixed image (the toner image transferred to the recording medium P) from being disturbed between the transfer region and the fixing region. For example, when a front end of the recording medium P passing through the transfer region is held by the grippers 54 in front of the fixing region, a transport member located between the transfer region and the fixing region needs to transport the recording medium P to the grippers 54. In this case, the transport member may come into contact with the recording medium to which the unfixed image is transferred, and the unfixed image may be disturbed. In addition, when a suction transport belt or the like is disposed, there is a possibility that the space may be large. By passing the recording medium P together with the grippers 54 through the nip region 28A while the recording medium P is held by the grippers 54, a posture of a tip end of the paper is maintained, and the transfer is performed in a state where the fluttering of the tip end of the paper is prevented. Further, after the recording medium P passes through the nip region 28A, it may be also possible to prevent the recording medium P from being transported in a state of being electrostatically adsorbed on the transfer belt 24. Further, the tip end of the recording medium P is less likely to touch a nip portion of the transfer, and an occurrence of jam when entering the nip region 28A is prevented.

The adsorption roller 59 is in contact with the transfer drum 28 on the upstream side in the transport direction with respect to the nip region 28A. The adsorption roller 59 presses the recording medium P against the transfer drum 28, and charges the recording medium P by supplying power from a power supply 57. As a result, the recording medium P is electrostatically adsorbed to the outer circumferential surface of the transfer drum 28.

In the rotation direction C of the chain 52, no sprocket is provided between passing through the nip region 28A and reaching the nip region 69A.

According to this configuration, compared with a configuration in which in the rotation direction C of the chain 52, the sprocket is provided between passing through the nip region 28A and reaching the nip region 69A, the chain 52 is wound so as to be linear from the time after the secondary transfer to the fixing, and the recording medium P on which the image is transferred is prevented from being bent and transported.

As illustrated in FIG. 1, the image forming apparatus 10 includes the non-contact heating unit 70 that heats the recording medium P in a non-contact state with the recording medium P between the secondary transfer body 27 and the fixing device 16 in the transport direction of the recording medium P. Here, the non-contact heating unit 70 includes a reflection plate 72 and plural infrared heaters 74 (hereinafter, referred to as “heaters 74”).

Reflection Plate 72

The reflection plate 72 is formed by using an aluminum plate, and has a bottom shallow box shape in which a recording medium P side (a lower side in FIG. 1) to be transported is opened. In the present exemplary embodiment, when viewed from above, the reflection plate 72 covers the transported recording medium P in an apparatus depth direction (a depth direction of a paper surface in FIG. 1).

Heater 74

The plural heaters 74 are infrared heaters having a columnar outer shape, are accommodated inside the reflection plate 72, and are disposed so as to extend in the apparatus depth direction. In the present exemplary embodiment, when viewed from above, the heater 74 covers the transported recording medium P in the apparatus depth direction. The plural heaters 74 are disposed in the apparatus width direction. The heater 74 is an example of the non-contact heating unit. Specifically, the heater 74 is a cylindrical infrared heater having a length in the apparatus front-rear direction. The plural (for example, 40) heaters 74 are disposed along the apparatus width direction inside the reflection plate 72. Specifically, the heater 74 includes a carbon filament (not shown) and a cylindrical quartz tube (not shown) accommodating the carbon filament therein. A black infrared radiation film is formed on a front surface of the quartz tube. As described above, since the black infrared radiation film is formed on the front surface of the quartz tube, for example, as compared with a case where a white film is formed, the heater efficiently emits infrared rays. In the present exemplary embodiment, a black color is a color in which chromaticity deviation from an achromatic color point (x=0.333, y=0.333, Y=0) is within 100 in a color difference ΔE. In the infrared heater 74 according to the present exemplary embodiment, a wavelength peak of a radiation wavelength of the infrared rays is set to 2 μm or more and 5 μm or less, and is a so-called far-infrared region. A surface temperature of a heater 74 of a heating unit 102 is a predetermined temperature of 300° C. or more and 1175° C. or less. In the present exemplary embodiment, a favorable heating distribution is obtained by arranging the heaters 74 that efficiently emit far-infrared rays with a density of 20 or more and 100 or less in the apparatus width direction with respect to the length of the reflection plate 72 in the apparatus width direction of 1 m.

When the toner on the recording medium is heated by transporting the recording medium having a wide width of A2 size or more such that the transport direction of the recording medium is a long side, in a case where the toner is heated by the heaters 74 of a number smaller than 20 per 1 m in the apparatus width direction, it is necessary to increase the voltage applied to the carbon filament in order to increase an output amount of the respective heaters 74. However, a temperature of the black infrared radiation film rises, and melting of the toner due to heat conduction from surrounding air heated by a near-infrared light component rather than the far-infrared rays becomes dominant. As a result, melting unevenness occurs between the vicinity of the heaters 74 and the heaters 74. On the other hand, by heating the toner with 20 or more heaters 74 per 1 m in the apparatus width direction, the carbon filament may be dominated by far-infrared radiation. Therefore, as compared with a case where the toner is heated by less than 20 heaters 74 per 1 m in the apparatus width direction, since the far-infrared rays, which are less dependent on a distance from a radiation source for toner melting, may be effectively used, the melting unevenness between the heaters 74 is reduced. In addition, when the toner is heated by the heaters 74 of a number larger than 100 per 1 m in the apparatus width direction, excessive far-infrared rays are radiated, so that it is difficult to control a temperature of an irradiated body to such an extent that the toner is melted, and in addition, since the fixing device 16 is heated by the heat of the toner and temperature control is difficult, the number of the heaters 74 may be 100 or less per 1 m in the apparatus width direction. In particular, when the recording medium of the B2 size or more is transported such that the transport direction of the recording medium is the long side, the number of the heaters 74 may be 30 or more and 50 or less per 1 m in the apparatus width direction.

Further, as illustrated in FIG. 1, in a side view, the image forming apparatus 10 may include a blowing unit 76 at a position facing the heater 74 with the chain 52 (specifically, in the rotation direction C of the chain 52, a portion on a downstream side of the sprocket 29 and on an upstream side of the sprocket 19) sandwiched. The blowing unit 76 includes a vent hole 80 facing a back surface of the recording medium P and a fan 78. The blowing unit 76 is an example of a blower.

### Actions of Present Exemplary Embodiment

Next, actions of the present exemplary embodiment will be described.

According to the image forming apparatus of the present exemplary embodiment, the front end portion of the recording medium P transmitted from the accommodating portion (not shown) in which the recording medium P is accommodated is held by the grippers 54, as illustrated in FIG. 5. Further, as illustrated in FIG. 3, the chains 52 rotate in the rotation direction C in the state in which the grippers 54 hold the front end portion of the recording medium P, thus the grippers 54 are moved to transport the recording medium P, and the recording medium P passes through the nip region 28A together with the grippers 54 while the recording medium P is held by the grippers 54. The recording medium P is electrostatically adsorbed to the transfer drum 28 by the adsorption roller 59 on the upstream side in the transport direction with respect to the nip region 28A.

When the recording medium P passes through the nip region 28A, the recording medium P is electrostatically adsorbed to the transfer belt 24 and the transfer drum 28 by the discharge of the discharge wire 60A in the charger 60. By the discharge of the discharge wire 60A in the charger 60, the toner image superimposed on the transfer belt 24 is transferred from the transfer belt 24 to the recording medium P in the nip region 28A, which is the secondary transfer position T2.

The recording medium P passing through the nip region 28A is transported to the fixing device 16 while being held by the grippers 54, and passes through the nip region 69A together with the grippers 54. The toner image is fixed to the recording medium P by passing through the nip region 69A.

In the present exemplary embodiment, since the chain 52 is stretched around the pair of sprockets 29 of the image forming unit 14 and the pair of sprockets 19 of the fixing device 16, the recording medium P held by the grippers 54 attached to the chain 52 is transported from the image forming unit 14 to the fixing device 16 by the rotation of the chain 52. Therefore, it may be possible to save space as compared with a configuration in which separate chains are used in the image forming unit 14 and the fixing device 16.

In the present exemplary embodiment, the chain 52 is wound around the sprocket 29 and the sprocket 19. Therefore, it may be possible to save space as compared with a configuration in which the chain 52 is bridged between the sprocket 29 and the sprocket 19 and is wound around other sprockets disposed on both sides with the sprocket 29 and the sprocket 19 sandwiched.

In the present exemplary embodiment, the maximum width portion 52W is formed from a portion where the chain 52 is wound around the sprocket 29 to a portion where the chain 52 is wound around the sprocket 19. Therefore, it may be possible to save space as compared with a configuration in which the maximum width portion 52W of the chain 52 corresponds to a portion wound around the other sprockets disposed on the both sides with the sprocket 29 and the sprocket 19 sandwiched.

In the present exemplary embodiment, in the electrophotographic image forming apparatus 10 using heat fixing, the grippers 54 transport the recording medium P by the rotation of the chain 52, and causes the recording medium P to pass through the nip region 28A and the nip region 69A. Therefore, as compared with a configuration in which by connecting plural pressure drums and delivering the recording medium P to the gripper of each pressure drum, the recording medium P is transported from the image forming unit 14 to the fixing device 16 and passes through the nip region 28A and the nip region 69A, since the heat of the heating roller 68 of the fixing device 16 is not transferred to the transfer drum 28 via the plural pressure drums, the transfer drum 28 is less likely to be affected by the heat.

In the present exemplary embodiment, as illustrated in FIG. 4, the outer diameter R1 of the pair of sprockets 29 is smaller than the outer diameter of the transfer drum 28. When the outer diameter R1 of the pair of sprockets 29 is equal to or larger than the outer diameter of the transfer drum 28, a circumferential speed of the sprockets 29 is larger than a circumferential speed of the transfer drum 28. Accordingly, a transport speed of the recording medium P held by the grippers 54 attached to the chain 52 wound around the sprockets 29 may be larger than the circumferential speed of the transfer drum 28. Accordingly, in the nip region 28A, the recording medium P may be pulled and displaced toward the downstream side in the transport direction with respect to the transfer drum 28 and the transfer belt 24.

On the other hand, in the present exemplary embodiment, as described above, since the outer diameter of the pair of sprockets 29 is smaller than the outer diameter of the transfer drum 28, the recording medium P may be prevented from being displaced toward the downstream side in the transport direction with respect to the transfer drum 28 and the transfer belt 24 in the nip region 28A, as compared with a configuration in which the outer diameter of the pair of sprockets 29 is equal to or larger than the outer diameter of the transfer drum 28.

In the present exemplary embodiment, the transfer drum 28 includes the base material 28E and the surface layer 28F that is wound around the outer circumference of the base material 28E and that is replaceable with respect to the base material 28E.

Therefore, when the surface layer 28F deteriorates, only the surface layer 28F needs to be replaced, and the secondary transfer body 27 including the pair of sprockets 29 does not need to be replaced.

In the present exemplary embodiment, as illustrated in FIG. 6, the outer diameter R2 of the pair of sprockets 19 is smaller than the outer diameter of the pressure roller 69. When the outer diameter R2 of the pair of sprockets 19 is equal to or larger than the outer diameter of the pressure roller 69, a circumferential speed of the sprocket 19 is larger than a circumferential speed of the pressure roller 69. Accordingly, the transport speed of the recording medium P held by the grippers 54 attached to the chain 52 wound around the sprockets 19 may be larger than the circumferential speed of the pressure roller 69. Accordingly, in the nip region 69A, the recording medium P may be pulled and displaced toward the downstream side in the transport direction with respect to the heating roller 68.

On the other hand, in the present exemplary embodiment, since the outer diameter R2 of the pair of sprockets 19 is smaller than the outer diameter of the pressure roller 69, the recording medium P may be prevented from being displaced toward the downstream side in the transport direction with respect to the heating roller 68 in the nip region 69A, as compared with a configuration in which the outer diameter R2 of the pair of sprockets 19 is equal to or larger than the outer diameter of the heating roller 69.

In the present exemplary embodiment, the pressure roller 69 includes the base material 69E and the surface layer 69F that is wound around the outer circumference of the base material 69E and that is replaceable with respect to the base material 69E.

Therefore, when the surface layer 69F deteriorates, only the surface layer 69F needs to be replaced, and the fixing device 16 including the pair of sprockets 19 does not need to be replaced.

In the present exemplary embodiment, the non-contact heating unit 70 that heats the recording medium P in the non-contact state with the recording medium P is included.

Therefore, as compared with a case in which the non-contact heating unit 70 that heats the recording medium P in the non-contact state with the recording medium P is not included between the secondary transfer body 27 and the fixing device 16 in the transport direction of the recording medium P, the image may be heated without contact with the recording medium P. By transporting the recording medium P from the nip region 28A to the nip region 69A while holding the recording medium P with the grippers 54, displacement of the recording medium P may be prevented as compared with a case where the recording medium P is not transported from the nip region 28A to the nip region 69A while holding the recording medium P.

Here, when duplex printing is performed, an image may already be formed on a surface (hereinafter referred to as a “back surface”) of the recording medium P at an opposite side of the surface to which the image is transferred. When the recording medium P is heated in a non-contact manner, the transport unit that is in contact with the back surface of the recording medium P and transports the recording medium P is heated by the heat received from the heaters 74, and the image on the back surface of the recording medium P in contact with the transport member may be disturbed. However, in the present exemplary embodiment, since the recording medium P is transported without contacting the back surface of the recording medium P in a region facing the heaters 74, the image on the back surface of the recording medium P may be prevented from being disturbed.

In the present exemplary embodiment, the blowing unit 76 is provided at a position facing the heaters 74 with the chain 52 sandwiched in a side view.

Therefore, when the fan 78 blows air toward the back surface of the recording medium P, the posture of the recording medium P is stabilized such that a sheet surface of the recording medium P transported between the blowing unit 76 and the heaters 74 is oriented in a vertical direction. That is, by controlling a force of the air blown from the fan 78, a rear end of the transported recording medium P may be prevented from moving downward with respect to the front end of the recording medium P. The vent hole 80 is not directed to the surface of the recording medium P to which the image is transferred. Therefore, the image transferred to the recording medium P may be prevented from being cooled.

The blowing unit 76 is an example of a support unit that supports the paper, which is the recording medium P so as not to significantly bend the posture of the paper while maintaining the non-contact state such that the back surface of the recording medium P at the opposite side of the front surface, which is the back surface in the image region where the unfixed image is formed on a front surface, is in the non-contact state and the recording medium P is transported by the transport unit 15. The blowing unit 76 is an example of the blower that blows air to the back surface of the recording medium P transported by the transport unit 15. The recording medium P may be transported while maintaining the non-contact state only by the blower serving as both the transport unit and the blower.

The blowing unit 76 blows air to the back surface of the recording medium P transported by the grippers 54, so that the recording medium P floats. Accordingly, the back surface of the recording medium P is brought into the non-contact state. Specifically, at least the back surface of the recording medium P in the image region is in the non-contact state. More specifically, at least the back surface of the recording medium P in the image region is in the non-contact state with respect to the front surface of the blowing unit 76. Therefore, the blowing unit 76 has a function of maintaining the non-contact state such that the recording medium P is transported by the grippers 54 in a state where the back surface of the recording medium P in the image region is in the non-contact state. The back surface of the recording medium P outside the image region is allowed to come into contact with the front surface of the blowing unit 76. It is necessary to prevent the air blown from a blower port of the blowing unit 76 from being directly supplied to the front surface of the recording medium P. A reason is that the image forming apparatus 10 of the present exemplary embodiment is an image forming apparatus of a system in which an image is formed using a dry toner, and when the air is directly supplied from the blower port to the front surface of the recording medium P, there is a possibility that an unfixed toner image may be disturbed. By supplying the air only to the back surface of the recording medium P, it may be possible to prevent the toner transferred to the front surface of the recording medium P from being cooled.

In the present exemplary embodiment, the blowing unit 76 extends upstream of the heating region in the transport direction. In other words, a blowing region set by the blowing unit 76 is set to be longer toward the upstream side in the transport direction of the recording medium P than the heating region set by the above non-contact heating unit. Therefore, before the tip end of the recording medium P enters the heating region and before the rear end of the recording medium P passes through the transfer region, the blowing unit 76 supports the posture of the recording medium P, and the recording medium P is transported to the heating region in a state where the posture of the recording medium P is stable. In addition, since the recording medium P is floated when the recording medium P is sandwiched between the grippers 54 and the transfer region, the fluttering of the recording medium P before the recording medium P enters the heating region may be more likely to be prevented than when the recording medium P receives air blowing from the blowing unit 76 after the recording medium P exits the transfer region. In other words, since the blowing unit 76 supports the recording medium P when the recording medium P is supported by the grippers 54 and the transfer region, the blowing unit 76 can also be referred to as a medium support unit. Therefore, before the recording medium P enters the heating region, the recording medium P may be easily supported by the blowing unit 76. Further, even after the rear end of the recording medium P passes through the transfer region, the blowing unit 76 continues to support the recording medium P, so that unevenness may be less likely to occur in heating. Further, unfixed toner on the recording medium P may be prevented from coming into contact with other members in an apparatus. Small fans may be provided at regular intervals in the transport direction as long as the fans contribute to the support of the recording medium P. In the present exemplary embodiment, the blowing unit 76 may extend further downstream of the heating region in the transport direction. Accordingly, the recording medium P is supported by the blowing unit 76 until the rear end of the recording medium P passes through the heating region. As a result, the recording medium P may be supported by the blowing unit 76 until the rear end of the recording medium P completely exits.

As another exemplary embodiment in which the back surface of the recording medium P in the image region is in the non-contact state, for example, a configuration may be possible in which a portion other than the image region is held by the grippers 54 before the rear end of the recording medium P enters the transfer region. In addition, in the heating region from the transfer region, the front surface of the image region may not be in contact with the other members in terms of preventing the disturbance of the image.

In the present exemplary embodiment, a so-called corotron is used as the charger 60, but the charger 60 is not limited thereto. For example, a so-called scorotron having a grid may be used as the charger 60.

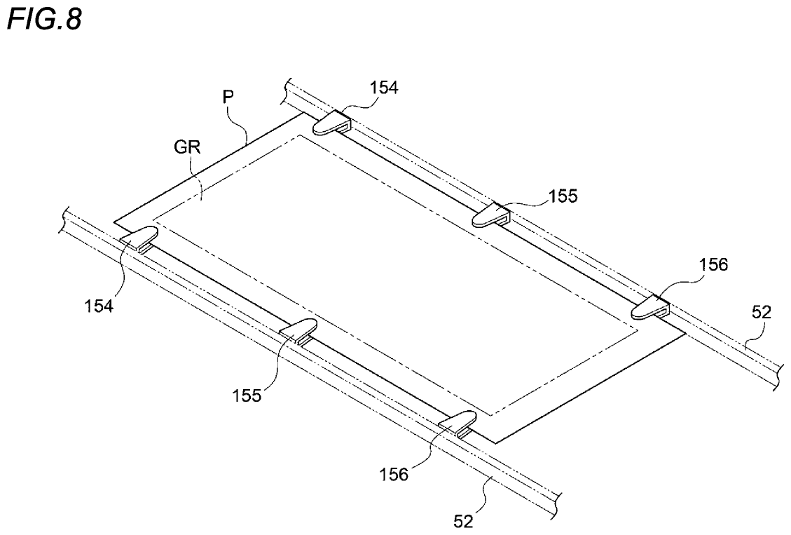

In the present exemplary embodiment, the gripper 54 as an example of the holding unit holds the front end portion of the recording medium P, but the holding unit is not limited thereto. For example, as illustrated in FIG. 8, grippers 154, 155, and 156 that hold side end portions of the recording medium P may be used as an example of the holding unit. In this configuration, the grippers 154, 155, and 156 hold the recording medium P outside a region GR where the toner image of the recording medium P is transferred. Also in this configuration, when the recording medium P is transported, the grippers 154, 155, and 156 pass through the nip region 28A in a side view. In FIG. 8, the chains 52 are simplified. FIG. 8 shows a state in which the recording medium P is transported between the sprocket 29 and the sprocket 19.

The holding unit may include only the grippers 154 that hold the front end side of the recording medium P. The front end side of the recording medium is a portion of the recording medium on a downstream side (front side) of a center in the transport direction. The holding unit is not necessarily required to hole the recording medium, and may be configured to adsorb the recording medium by air.

In the present exemplary embodiment, the chains 52 are used as an example of the rotating member, but the rotating member is not limited thereto. For example, a timing belt may be used as an example of the rotating member. In the present exemplary embodiment, the sprocket 29 is used as an example of the first rotating body, but the first rotating body is not limited thereto. For example, a timing pulley around which the timing belt is wound may be used as an example of the first rotating body. When the timing pulley is used as an example of the first rotating body, the timing pulley is used instead of the sprocket 19 as an example of the second rotating body. Further, the timing pulley is used instead of the sprockets 46, 47, and 48.

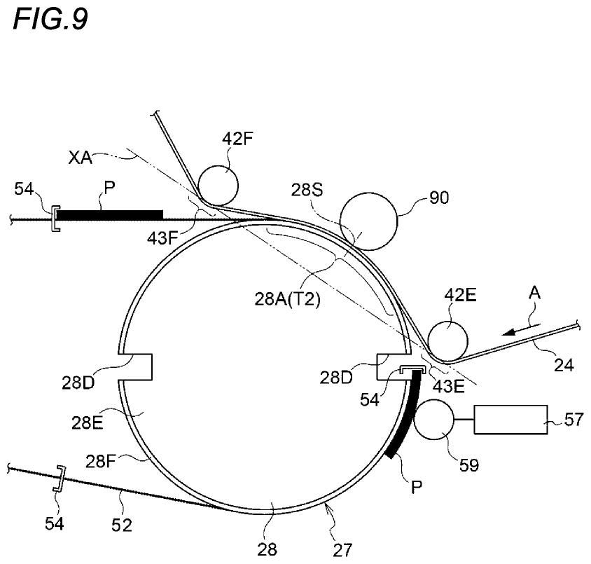

In the present exemplary embodiment, the charger 60 is used as an example of the facing portion, but the facing portion is not limited thereto. For example, the facing portion may be an opposing rotating body (including a pressing member and a pressed member that are in a pressing relationship with the transfer drum, such as a backup roller and a photoconductor) that comes into contact with the transfer belt 24 and presses the transfer drum 28, or is pressed by the transfer drum 28. In this case, the transfer drum may be fixed, and the rotating body biased by a spring may press the transfer drum or vice versa. For example, as illustrated in FIG. 9, in a case of a backup roller 90 in which the opposing rotating body or roller presses the transfer drum, the transfer device secondarily transfers the toner image formed on the transfer belt 24 to the recording medium P by passing the transfer belt 24 and the recording medium P between the transfer drum 28 and the backup roller 90 with the transfer belt 24 and the recording medium P sandwiched. A transfer bias voltage applied between the transfer drum 28 and the backup roller 90 is constituted by a direct current component (DC component), and the transfer drum 28 is grounded to a ground potential. In a configuration in which the backup roller 90 is disposed, a disturbance such as a collision of the pressing backup roller 90 against the recess 28D, which is an example of a cutout portion of the transfer drum 28, may occur, which may affect the rotation of the backup roller 90 and the transfer drum 28. As a result, a speed of the transfer belt 24 and the transfer drum 28 is affected, and an image registration is deteriorated. In such a configuration, when a moment of inertia of the transfer drum 28 is larger than a moment of inertia of the backup roller 90, as compared with one in which the moment of inertia of the transfer drum 28 and the moment of inertia of the backup roller 90 are equivalent, a rotation speed fluctuation of the transfer drum 28 due to the backup roller 90 is reduced, and the backup roller 90 receives a reaction force that reduces the speed fluctuation by the transfer drum, so that the transfer drum 28 may be less likely to be affected by the generated disturbance.

In addition, when a radius of the transfer drum 28 is large, the sprocket 29 also becomes relatively large, so that an amount of the chain 52 wound around the sprocket 29 increases. Therefore, the recording medium P may be likely to be conveyed along the front surface of the transfer drum 28.

In addition, when the moment of inertia of the transfer drum 28 is large, it may be difficult to receive a vibration of the chain 52.

In addition, even when the facing portion is not in contact with the transfer drum 28 as in the corotron or the like, there is no opposing rotating body, so that the transfer drum 28 may be less likely to be subjected to the disturbance.

In the nip region 28A, the surface layer 28F of the transfer drum 28 rotates while being pressed (while being elastically deformed) by the backup roller 90 via the transfer belt 24. Accordingly, the recording medium P and the transfer belt 24 are brought into close contact with each other.

As a method of increasing the moment of inertia of the transfer drum 28, a method of disposing a flywheel coaxially with the transfer drum 28 may be used.

Further, in the present exemplary embodiment, the transfer drum 28 is provided as an example of a transfer body, and a cylindrical rotating body that is not hollow may be provided.

In the present exemplary embodiment, the heating roller 68 is used as an example of the heating unit, but the heating unit is not limited thereto. For example, a heating belt that comes into contact with the pressure roller 69 may be used as an example of the heating unit.

In the present exemplary embodiment, the heater 74 is used as an example of the non-contact heating unit, but the non-contact heating unit is not limited thereto. For example, a halogen lamp may be used as an example of the non-contact heating unit.

In the present exemplary embodiment, the transfer drum 28 is rotationally driven to rotate the chain 52, but the present invention is not limited to this configuration. For example, the chain 52 may be rotated by rotationally driving the pressure roller 69 and using the transfer drum 28 as a driven rotation instead, or the chain 52 may be rotated in synchronization with the rotation of the transfer drum 28 and the pressure roller 69. The chain 52 may be rotated by using the pressure roller 69 and the transfer drum 28 as the driven rotation, respectively, and rotationally driving the other sprockets.

In the present exemplary embodiment, the chain 52 is wound around the sprockets 19, 29, 46, 47, and 48, but the present invention is not limited to this configuration. For example, the chain 52 may be wound only around the sprockets 19 and 29 without providing the sprockets 46, 47, and 48.

In the present exemplary embodiment, although the present invention is applied to the electrophotographic image forming apparatus 10, the present invention is not limited to this configuration, and the present invention may be applied to a known image forming apparatus other than the electrophotographic type image forming apparatus. For example, the present invention may be applied to an inkjet type image forming apparatus. In this case, the image forming unit includes an inkjet head as an example of a forming unit that forms an image on the recording medium P by discharging liquid droplets to the recording medium P supported by a rotating drum, and the fixing unit includes a drying unit that dries the liquid droplets discharged to the recording medium P. An aspect may be adopted in which an image is formed by discharging the liquid droplets of the respective colors toward an ink receiving body held on an intermediate transfer belt, and the ink receiving body on which the image is formed is transferred to the recording medium P. As an aspect to which the present invention is applied, an aspect may be adopted in which the recording medium is transported in a state in which a coloring material does not penetrate into the recording medium, such as powder coating. The recording medium is not limited to paper, and may be a medium such as a label in which ink or the coloring material does not easily penetrate (part thereof permeates) or does not permeate.

The present invention is not limited to the above-described exemplary embodiment, and various modifications, changes, and improvements may be possible without departing from the gist of the present invention. For example, plural modifications described above may be combined as appropriate.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that comprises a first drum supporting a recording medium and a first rotating body disposed at an axial end of the first drum, and that is configured to form an image on the recording medium;
a fixing unit that comprises a second drum supporting the recording medium and a second rotating body disposed at an axial end of the second drum, and that is configured to fix the image to the recording medium by heating or drying the recording medium; and
a transport unit that comprises a rotating member stretched between the first rotating body and the second rotating body and rotating with rotation of the first rotating body and the second rotating body and a holding unit attached to the rotating member and holding the recording medium, and that is configured to transport the recording medium from the image forming unit to the fixing unit by the rotation of the rotating member.

2. The image forming apparatus according to claim 1, wherein
the rotating member is wound around the first rotating body and the second rotating body.

3. The image forming apparatus according to claim 2, wherein
a maximum width of the transport unit in a width direction of the image forming apparatus is a length from a portion of the rotating member wound around the first rotating body to a portion of the rotating member wound around the second rotating body.

4. The image forming apparatus according to claim 1, wherein
the image forming unit further comprises an annular transfer belt on which an image is transferred to an outer surface,
the first drum is a transfer drum having a transfer region where the image is transferred from the transfer belt to the recording medium by sandwiching the recording medium with the outer surface of the transfer belt,
the fixing unit further comprises a heating unit,
the second drum is a pressure roller having a fixing region in which the image is fixed to the recording medium by sandwiching the recording medium with an outer surface of the heating unit, and
the transport unit is configured to transport the recording medium by the rotation of the rotating member, and cause the recording medium to pass through the transfer region and the fixing region.

5. The image forming apparatus according to claim 2, wherein
the image forming unit further comprises an annular transfer belt on which an image is transferred to an outer surface,
the first drum is a transfer drum having a transfer region where the image is transferred from the transfer belt to the recording medium by sandwiching the recording medium with the outer surface of the transfer belt,
the fixing unit further comprises a heating unit,
the second drum is a pressure roller having a fixing region in which the image is fixed to the recording medium by sandwiching the recording medium with an outer surface of the heating unit, and
the transport unit is configured to transport the recording medium by the rotation of the rotating member, and cause the recording medium to pass through the transfer region and the fixing region.

6. The image forming apparatus according to claim 3, wherein
the image forming unit further comprises an annular transfer belt on which an image is transferred to an outer surface,
the first drum is a transfer drum having a transfer region where the image is transferred from the transfer belt to the recording medium by sandwiching the recording medium with the outer surface of the transfer belt,
the fixing unit further comprises a heating unit,
the second drum is a pressure roller having a fixing region in which the image is fixed to the recording medium by sandwiching the recording medium with an outer surface of the heating unit, and
the transport unit is configured to transport the recording medium by the rotation of the rotating member, and cause the recording medium to pass through the transfer region and the fixing region.

7. The image forming apparatus according to claim 4, further comprising:
a non-contact heating unit that is provided between the image forming unit and the fixing unit in a transport direction of the recording medium, and that is configured to heat the image transferred to the recording medium in a non-contact manner.

8. The image forming apparatus according to claim 5, further comprising:
a non-contact heating unit that is provided between the image forming unit and the fixing unit in a transport direction of the recording medium, and that is configured to heat the image transferred to the recording medium in a non-contact manner.

9. The image forming apparatus according to claim 6, further comprising:
a non-contact heating unit that is provided between the image forming unit and the fixing unit in a transport direction of the recording medium, and that is configured to heat the image transferred to the recording medium in a non-contact manner.

10. The image forming apparatus according to claim 7, further comprising:
a blower that faces the non-contact heating unit with the rotating member sandwiched, and that is configured to blow air to a back surface of the recording medium transported by the transport unit at an opposite side of a surface to which the image is transferred.

11. The image forming apparatus according to claim 8, further comprising:
a blower that faces the non-contact heating unit with the rotating member sandwiched, and that is configured to blow air to a back surface of the recording medium transported by the transport unit at an opposite side of a surface to which the image is transferred.

12. The image forming apparatus according to claim 9, further comprising:
a blower that faces the non-contact heating unit with the rotating member sandwiched, and that is configured to blow air to a back surface of the recording medium transported by the transport unit at an opposite side of a surface to which the image is transferred.

13. The image forming apparatus according to claim 4, wherein
an outer diameter of the first rotating body is smaller than an outer diameter of the transfer drum.

14. The image forming apparatus according to claim 4, wherein
the transfer drum comprises a base material and a surface layer that is wound around an outer circumference of the base material and that is replaceable with respect to the base material.

15. The image forming apparatus according to claim 4, wherein
an outer diameter of the second rotating body is smaller than an outer diameter of the pressure roller.

16. The image forming apparatus according to claim 4, wherein
the pressure roller comprises a base material and a surface layer that is wound around an outer circumference of the base material and that is replaceable with respect to the base material.
